(19) United States
(12) Patent Application Publication
(10) Pub. No.: US 2014/0075124 A1
(43) Pub. Date: Mar. 13, 2014

(54) Selective Delaying of Write Requests in Hardware Transactional Memory Systems

(71) Applicants: Colin B. Blundell, West Allenhurst, NJ (US); Harold Wade Cain, III, Katonah, NY (US); Jose Eduardo Moreira, Irvington, NY (US)

(72) Inventors: Colin B. Blundell, West Allenhurst, NJ (US); Harold Wade Cain, III, Katonah, NY (US); Jose Eduardo Moreira, Irvington, NY (US)

(73) Assignee: International Business Machines Corporation, Armonk, NY (US)

(21) Appl. No.: 13/606,973

(22) Filed: Sep. 7, 2012

(51) Int. Cl. G06F 12/08

(52) U.S. Cl. 711/135; 711/E12.022

(57) ABSTRACT

Techniques for conflict detection in hardware transactional memory (HTM) are provided. In one aspect, a method for detecting conflicts in HTM includes the following steps. Conflict detection is performed eagerly by setting read and write bits in a cache as transactions having read and write requests are made. A given one of the transactions is stalled when a conflict is detected whereby more than one of the transactions are accessing data in the cache in a conflicting way. An address of the conflicting data is placed in a predictor. The predictor is queried whenever the write requests are made to determine whether they correspond to entries in the predictor. A copy of the data corresponding to entries in the predictor is placed in a store buffer. The write bits in the cache are set and the copy of the data in the store buffer is merged in at transaction commit.

### FIELD OF THE INVENTION

The present invention relates to conflict detection in hardware transactional memory and more particularly, to techniques for conflict detection in hardware transactional memory wherein either easy or lazy conflict detection is performed for each store based on a past behavior of the store.

### BACKGROUND OF THE INVENTION

Hardware transactional memory systems execute regions of code called transactions speculatively in parallel while maintaining the guarantee that the final result is the same as that of an execution in which each transaction executed serially. In order to enforce this guarantee, hardware transactional memory systems have to detect cases where two simultaneously-executing transactions are accessing the same piece of data in a conflicting way (i.e., at least one of the two accesses is a write). On detecting such a conflict, the hardware transactional memory system preserves the appearance of serial execution by stalling or rolling back one of the conflicting transactions.

Known solutions to the problem of conflict detection in hardware transactional memory fall into two main classes: eager and lazy. These two schemes differ in how they handle writes. Eager conflict detection systems perform conflict detection on writes at the time that the writes are executed. By contrast, lazy conflict detection systems typically queue all writes to be performed at transaction commit, at which time conflict detection is performed between these writes and the memory accesses made by other transactions.

The two schemes carry a complexity/performance tradeoff. Eager conflict detection is largely compatible with existing multiprocessor coherence protocols and memory systems (e.g., it can be implemented by adding bits to cache lines that are set on local memory accesses and checked for conflicts on incoming coherence requests). However, the performance of systems employing eager conflict detection can suffer relative to systems employing lazy conflict detection: by deferring writes made by a transaction until that transaction commits, a lazy conflict detection system gives competing reader transactions a greater window of opportunity to commit than does an eager conflict detection system. Proposals for implementing lazy conflict detection, however, typically employ mechanisms that are not present in current multiprocessor memory systems, e.g., mechanisms to enforce global ordering between all transactions in a system and/or mechanism to acquire coherence permissions for a set of stores in a single atomic operation requiring a means of iterating over the set of all transactionally written cache lines.

Therefore, techniques for detecting conflicts in hardware transactional memory that provide the benefits of both an eager conflict detection system and a lazy conflict detection system would be desirable.

### SUMMARY OF THE INVENTION

The present invention provides techniques for conflict detection in hardware transactional memory wherein either easy or lazy conflict detection is performed for each store based on a past behavior of the store. In one aspect of the invention, a method for detecting conflicts in hardware transactional memory is provided. The method includes the following steps. Conflict detection is performed eagerly by setting read bits and write bits in a cache as transactions comprising read requests and write requests are made. A given one of the transactions is stalled when a conflict is detected whereby more than one of the transactions are accessing data in the cache in a conflicting way. An address of the data in the cache being accessed by more than one of the transactions in a conflicting way is placed in a delay prediction table. The delay prediction table is queried whenever the write requests are made to determine whether the write requests correspond to data in the cache having entries in the delay prediction table. A copy of the data in the cache having entries in the delay prediction table is placed in a store buffer if the delay prediction table returns a positive result, otherwise performing the conflict detection eagerly. The write bits in the cache are set and the copy of the data in the store buffer is merged in at transaction commit.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating exemplary methodology for detecting conflicts in hardware transactional memory according to an embodiment of the present invention;

FIG. 2 is a schematic diagram illustrating an exemplary system for detecting conflicts in hardware transactional memory according to an embodiment of the present invention;

FIG. 3 is a diagram illustrating an exemplary methodology for updating the delay prediction table according to an embodiment of the present invention;

FIG. 4 is a diagram illustrating an exemplary methodology for processing a store request according to an embodiment of the present invention; and

FIG. 5 is a diagram illustrating an exemplary apparatus for performing one or more of the methodologies presented herein according to an embodiment of the present invention.

### DETAILED DESCRIPTION OF PREFERRED EMBODIMENTS

As described above, either a lazy approach or an eager approach to conflict detection in hardware transactional memory has benefits and tradeoffs. For example, eager conflict detection is largely compatible with existing multiprocessor coherence protocols and memory systems. However, the performance of systems employing eager conflict detection can suffer relative to systems employing lazy conflict detection (i.e., by deferring writes made by a transaction until that transaction commits, a lazy conflict detection system gives competing reader transactions a greater window of opportunity to commit than does an eager conflict detection system). Lazy conflict detection schemes, however typically employ mechanisms that are not present in current multiprocessor memory systems.

Advantageously, the present techniques provide a means to extract the benefits of both a lazy conflict detection scheme and an eager conflict detection scheme in hardware transactional memory by selectively choosing for each store whether to eagerly or lazily perform conflict detection based on a past behavior of the store.

Namely, the present techniques employ a predictor (also referred to herein as a “delay prediction table”) that is trained on transaction conflicts. This predictor is used to determine when to delay a given write request until the transaction commits (lazy conflict detection). If it is determined that a given write request should be delayed, then the request is sent as a read request. The locally-modified data is stored in the store buffer. At transaction commit, a write request is made for the block. When the write request completes, the data in the store buffer is merged into the current value of the block in the cache.

The advantages of such a scheme relative to a completely lazy or completely eager conflict detection policy are the following. By separating accesses into two sets, accesses that should be delayed and accesses that should be performed eagerly, the policy: 1) Unlike a completely lazy conflict resolution policy, it can proactively acquire coherence permissions for uncontended cache lines, significantly reducing commit-time stalls for such acquisitions. 2) Unlike a completely eager conflict resolution policy, it can delay acquiring coherence permissions for contended cache lines until commit, reducing the window of vulnerability for transaction abort due to conflict and thereby improving transaction success rates and scalability. 3) It can achieve these benefits while consuming fewer hardware resources as compared to a full lazy conflict resolution protocol, since only a subset of the set of transactional stores is delayed. Thus, the present process gets the best of both worlds in terms of lazy and eager conflict detection.

The present techniques take advantage of the discovery that a small set of memory locations and program counters (PCs) is responsible for a majority of conflicts. By way of example only, with Memcached running on cycle-mode Mambo (32 cores) it was found that 89 percent (%) of all conflicts occur due to only four cache lines, and 90% of all conflicts occur due to only three PCs.

According to the present techniques, it was found by way of this discovery that the advantages of lazy conflict detection can be obtained by delaying only a small set of writes. Thus, the best of both worlds can be had: there is a smaller window of vulnerability for contended memory locations, as well as a lower latency commit than an all-lazy policy—since locations where eager policy is used have acquired coherence permissions before committing.

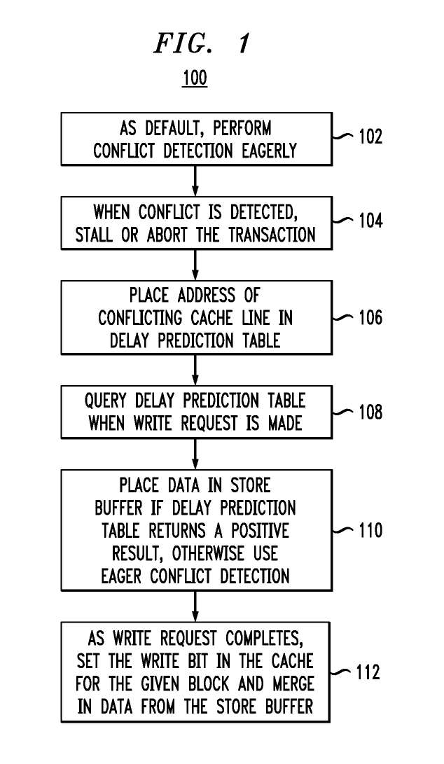

FIG. 1 is a diagram illustrating exemplary methodology 100 for detecting conflicts in hardware transactional memory. FIG. 1 provides an overview of the present techniques. In general, in methodology 100 a choice is made, selective for each store, as whether to eagerly or lazily perform conflict detection for the store based on past behavior of that store.

Specifically, in step 102, the processor performed conflict detection eagerly, i.e., the processor sets read and write bits in the cache as the transaction make read and write requests. This is the default condition. As provided above, hardware transactional memory systems execute transactions speculatively in parallel. In order to do so, hardware transactional memory systems have to detect cases where two simultaneously-executing transactions are accessing the same piece of data in a conflicting way, i.e., at least one of the two accesses is a write. On detecting such a conflict, the hardware transactional memory system preserves the appearance of serial execution by stalling or rolling back one of the conflicting transactions.

In step 104, when a conflict is detected on a cache block with the write bit set—i.e., at least one of the two accesses is a write, the transaction stalls or aborts (as dictated by the underlying conflict resolution policy). In step 106, the address (physical address (PA)) of the conflicting cache line is placed in a delay prediction table (also referred to herein as a “predictor table” or simply a “predictor”). The delay prediction table will be described in detail below. Generally, however, the delay prediction table contains a single bit indicating whether coherence permissions should be acquired lazily or eagerly. An exemplary methodology for updating the delay prediction table is shown in FIG. 3, described below.

When a write request is made, in step 108, the delay prediction table is queried with the address of the write request, i.e., in order to determine whether the write request corresponds to a conflicting cache line. If the delay prediction table returns a positive result (i.e., indicating that the write request corresponds to a conflicting cache line—i.e., the write request corresponds to cache data having an entry in the delay prediction table), then in step 110, rather than acquiring write permission for the cache block (as per an eager scenario), the data is also placed (i.e., a copy of the data is placed) in a thread-private store buffer (also referred to herein simply as a “store buffer”). The store buffer will be described in detail below. All stores to this block that occur during the transaction are made to the copy that is in the store buffer. Optionally, at the time that the write is placed in the store buffer, a read request for the complete cache line can be made, in order to prefetch nearby data contained in the line. On the other hand, if the delay prediction table returns a negative result (i.e., indicating that the write request does not correspond to a conflicting cache line—i.e., the write request does not correspond to cache data having an entry in the delay prediction table), then the eager conflict detection is used to process the transaction.

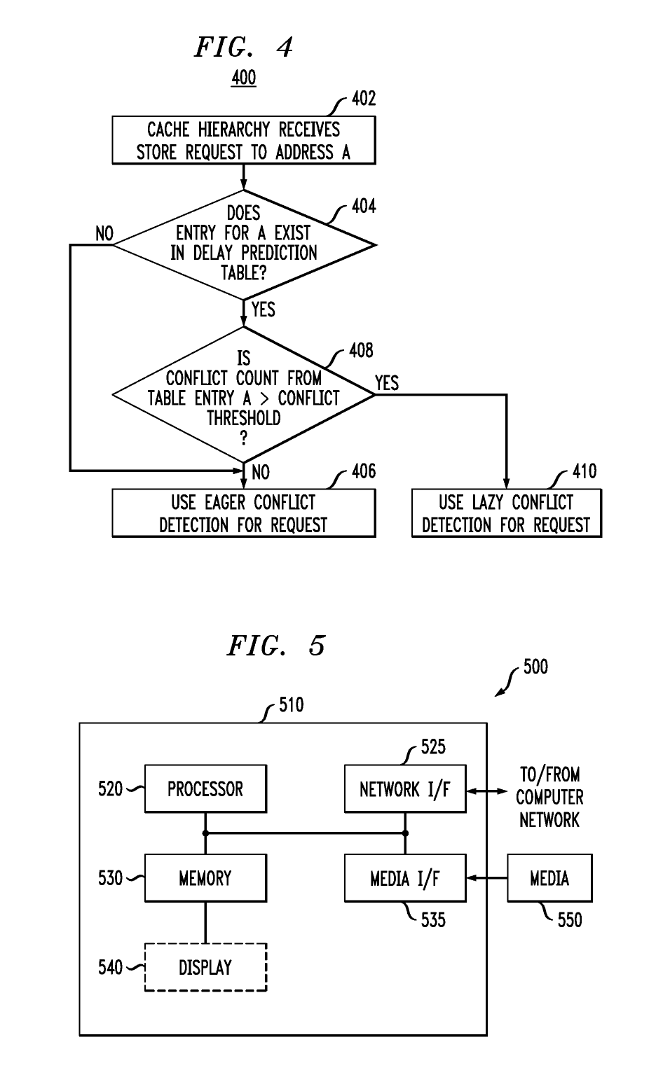

At the time of transaction commit, the transaction makes write requests for all blocks for which writes have been delayed. As each write request completes, in step 112, the processor sets the write bit in the cache for the given block and merges in the data from the store buffer. When all write requests are complete, the transaction commits. This process for handling requests from the store buffer is illustrated in FIG. 4, described below.

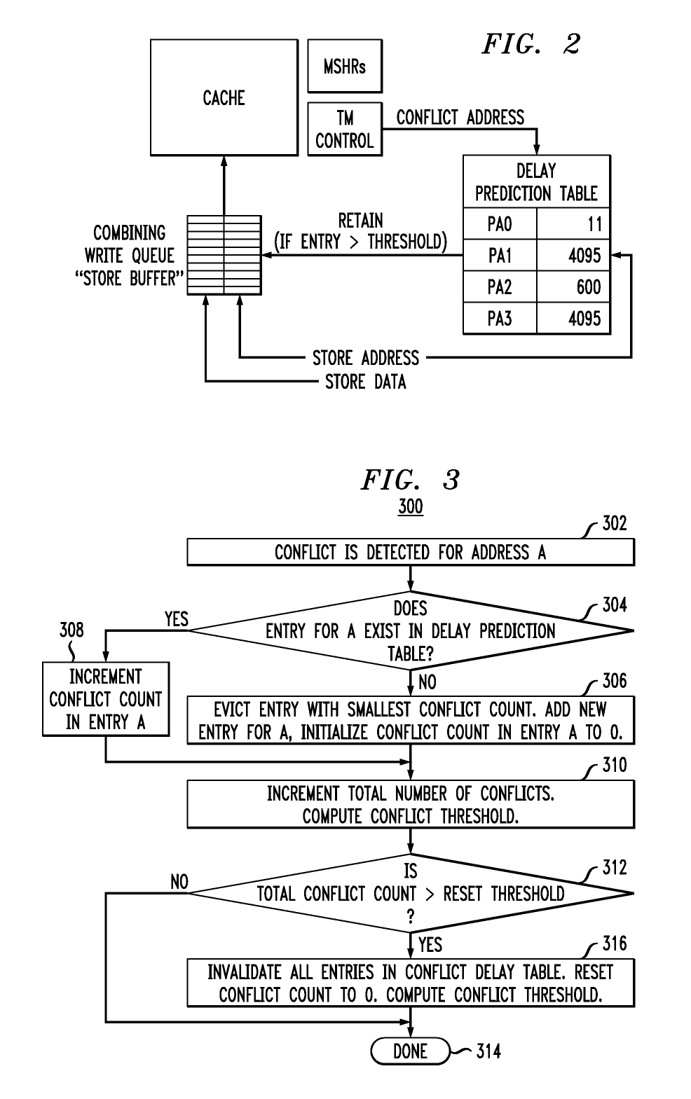

FIG. 2 is a schematic diagram illustrating a system for detecting conflicts in hardware transactional memory including the delay prediction table and the store buffer. As shown in FIG. 2, and as known in the art, the cache has misinformation/status holding registers (MSHRs) and a transactional memory (TM) control associated therewith. The general operation of MSHRs and TM controls associated with a cache are known to those of skill in the art and thus are not described further herein. As described, for example, in conjunction with the description of FIG. 1, above, when a conflict is detected, the address of the conflicting cache line is placed in the delay prediction table. In the exemplary embodiment shown in FIG. 2, this action labeled “Conflict address” is carried out via the TM control. As shown in FIG. 2, the delay prediction table contains a plurality of physical addresses (PA 0, . . . , PA 3) corresponding to conflicting cache lines. This action is labeled “store address” in FIG. 2.

The predictor is a table indexed by a portion of the physical address of the conflicting cache line, containing a single bit indicating whether coherence permissions should be acquired lazily or eagerly. The entries in the delay prediction table may be tagged (similar to a cache), or may be tagless. The delay prediction table may be periodically cleared in order to retrain the mechanism for changing workload behavior.

As described above, whenever a write request is made, the delay prediction table is queried in order to determine whether the write request corresponds to a conflicting cache line in the table. If the delay prediction table returns a positive results, then the data is placed in the store buffer. This action is labeled “store data” in FIG. 2.

As will be described in detail below, the delay prediction table has a conflict counter associated therewith which keeps track of the overall number of conflicts in the delay prediction table as well as the number of conflicts in the delay prediction table associated with a given PA. A threshold is set for the number of conflicts associated with a particular address. Once the threshold is exceeded, then lazy conflict detection is used for the request. This action is labeled “retain” in FIG. 2. By way of example only, if a store request is received to PA (address) A and an entry already exists in the delay prediction table for address A, and if the conflict count for address A (determined from the delay prediction table) is greater than the conflict threshold, then lazy conflict detection will be used for the request. This scenario will be explored in further detail below.

FIG. 3 is a diagram illustrating an exemplary methodology 300 for updating the delay prediction table when a conflict is detected. Namely, in step 302, a conflict is detected on a cache block, in this case the conflicting cache line has address “A”. In step 304 a determination is made as to whether (or not) an entry for address A is already present in the delay prediction table. If an entry for address A is not present in the delay prediction table, then in step 306, the entry in the delay prediction table having the lowest/smallest conflict count (see above) is evicted/removed from the delay prediction table and a new entry for address A is added to the delay prediction table wherein the conflict count for address A entry in the delay prediction table is initialized to 0.

On the other hand, if an entry for address A is already present in the delay prediction table, then in step 308, the conflict count (see above) in the table entry for address A is incremented. Next, in step 310, the total number of conflicts in the table is incremented based on this newest detected conflict. A conflict threshold is computed.

A determination is then made in step 312 as to whether (or not) the (incremented) conflict count exceeds the reset threshold. If the current conflict count does not exceed the reset threshold then in step 314, the process is complete until the next conflict is detected. On the other hand, if the current conflict count exceeds the reset threshold then in step 316, all entries in the delay prediction table are invalidated and the conflict count is reset to 0. The conflict threshold is the re-computed.

FIG. 4 is a diagram illustrating exemplary methodology 400 for processing a store request. Namely, as provided above, when a write request is made the delay prediction table is queried to determine whether (or not) the write request corresponds to a conflicting cache line in the delay prediction table. This request is also being referred to herein as a store request. Namely, in step 402, a store request to address A is received. In step 404, a determination is made as to whether (or not) an entry exists for address A in the delay prediction table. If an entry does not exist for address A in the delay prediction table, then in step 406, eager conflict detection is used for the request.

On the other hand, if an entry does exist for address A in the delay prediction table, then in step 408 a determination is made as to whether (or not) the conflict count in the delay prediction table for address A (see above) is above a conflict threshold. If the conflict count in the delay prediction table for address A is not above the conflict threshold, then as per step 406 eager conflict detection is used for the request. On the other hand, if the conflict count in the delay prediction table for address A is above the conflict threshold, then as per step 410 lazy conflict detection is used for the request.

Turning now to FIG. 5, a block diagram is shown of an apparatus 500 for implementing one or more of the methodologies presented herein. By way of example only, apparatus 500 can be configured to implement one or more of the steps of methodology 100 of FIG. 1 for detecting conflicts in hardware transactional memory.

Apparatus 500 comprises a computer system 510 and removable media 550. Computer system 510 comprises a processor device 520, a network interface 525, a memory 530, a media interface 535 and an optional display 540. Network interface 525 allows computer system 510 to connect to a network, while media interface 535 allows computer system 510 to interact with media, such as a hard drive or removable media 550.

As is known in the art, the methods and apparatus discussed herein may be distributed as an article of manufacture that itself comprises a machine-readable medium containing one or more programs which when executed implement embodiments of the present invention. For instance, when apparatus 500 is configured to implement one or more of the steps of methodology 100 the machine-readable medium may contain a program configured to perform conflict detection eagerly by setting read bits and write bits in a cache as transactions comprising read requests and write requests are made; stall a given one of the transactions when a conflict is detected whereby more than one of the transactions are accessing data in the cache in a conflicting way; place an address of the data in the cache being accessed by more than one of the transactions in a conflicting way in a delay prediction table; query the delay prediction table whenever the write requests are made to determine whether the write requests correspond to data in the cache having entries in the delay prediction table; place a copy of the data in the cache having entries in the delay prediction table in a store buffer if the delay prediction table returns a positive result, otherwise performing the conflict detection eagerly; and set the write bits in the cache and merging in the copy of the data in the store buffer at transaction commit.

The machine-readable medium may be a recordable medium (e.g., floppy disks, hard drive, optical disks such as removable media 550, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

Processor device 520 can be configured to implement the methods, steps, and functions disclosed herein. The memory 530 could be distributed or local and the processor device 520 could be distributed or singular. The memory 530 could be implemented as an electrical, magnetic or optical memory, or any combination of these or other types of storage devices. Moreover, the term “memory” should be construed broadly enough to encompass any information able to be read from, or written to, an address in the addressable space accessed by processor device 520. With this definition, information on a network, accessible through network interface 525, is still within memory 530 because the processor device 520 can retrieve the information from the network. It should be noted that each distributed processor that makes up processor device 520 generally contains its own addressable memory space. It should also be noted that some or all of computer system 510 can be incorporated into an application-specific or general-use integrated circuit.

Optional display 540 is any type of display suitable for interacting with a human user of apparatus 500. Generally, display 540 is a computer monitor or other similar display.

Some further options for the present techniques include 1) a design where the program counter (PC) is used as an index to predictor, rather than physical address (PA), 2) for designs that do not already use combining write buffers, storage of data can be incorporated into the predictor design, 3) alternatively, the predictor could be integrated into the cache's tag metadata, marking lines for which coherence actions should be delayed (this can be done for valid as well as invalid lines), 4) modifications to the coherence protocol can be made to detect cases where a write miss cause conflict in another cache, indicated by another bit in response messages, 5) a predictor that is indexed by a subset of the bits in the PA or PC, or a logical or arithmetic combination of the two, 6) a predictor that tracks addresses on coarse regions of memory, rather than a word or cache line basis.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for detecting conflicts in hardware transactional memory, the method comprising the steps of:
performing conflict detection eagerly by setting read bits and write bits in a cache as transactions comprising read requests and write requests are made;
stalling a given one of the transactions when a conflict is detected whereby more than one of the transactions are accessing data in the cache in a conflicting way;
placing an address of the data in the cache being accessed by more than one of the transactions in a conflicting way in a delay prediction table;
querying the delay prediction table whenever the write requests are made to determine whether the write requests correspond to data in the cache having entries in the delay prediction table;
placing a copy of the data in the cache having entries in the delay prediction table in a store buffer if the delay prediction table returns a positive result, otherwise performing the conflict detection eagerly; and
setting the write bits in the cache and merging in the copy of the data in the store buffer at transaction commit.

2. The method of claim 1, wherein the delay prediction table comprises a plurality of physical addresses corresponding to the data in the cache being accessed by more than one of the transactions in a conflicting way.

3. The method of claim 2, wherein the delay prediction table has a counter associated therewith configured to keep track of an overall number of conflicts in the delay prediction table.

4. The method of claim 2, wherein the delay prediction table has a counter associated therewith configured to keep track of a number of conflicts in the delay prediction table associated with a given one of the physical addresses.

5. The method of claim 1, further comprising the step of:
clearing the delay prediction table to accommodate changing workload behavior.

6. The method of claim 1, further comprising the step of:
determining whether the address of the data in the cache being accessed by more than one of the transactions in a conflicting way exists in the delay prediction table.

7. The method of claim 6, wherein the address of the data in the cache being accessed by more than one of the transactions in a conflicting way does not exist in the delay prediction table, the method further comprising the steps of:
evicting an entry in the delay prediction table having a smallest conflict count and adding a new entry for the address of the data in the cache being accessed by more than one of the transactions in a conflicting way; and
incrementing a total number of conflicts in the delay prediction table.

8. The method of claim 6, wherein the address of the data in the cache being accessed by more than one of the transactions in a conflicting way does exist in the delay prediction table, the method further comprising the steps of:
incrementing a conflict count in the delay prediction table for the address of the data in the cache being accessed by more than one of the transactions in a conflicting way; and
incrementing a total number of conflicts in the delay prediction table.

9. The method of claim 5, further comprising the steps of:
determining whether a total number of conflicts in the delay prediction table exceeds a reset threshold; and
invalidating all entries in the delay prediction table if the total number of conflicts in the delay prediction table exceeds the reset threshold.

10. The method of claim 9, further comprising the step of:
resetting a conflict count of the delay prediction table.
